(19) United States
(12) Patent Application Publication
(10) Pub. No.: US 2009/0171967 A1
(43) Pub. Date: Jul. 2, 2009

(54) SYSTEM AND METHOD FOR PROVIDING DESCRIPTION DIVERSITY

(76) Inventor: Maciej Ceglowski, San Francisco, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(21) Appl. No.: 11/964,916

(22) Filed: Dec. 27, 2007

(51) Int. Cl. G06F 17/30

(52) U.S. Cl. 707/10; 707/104.1; 707/E17.044

(57) ABSTRACT

The present invention is directed towards systems and methods for ranking a plurality of social bookmarks. The method of the present invention comprises receiving a bookmark request, the request comprising an identification of a resource and a plurality of resource tags. Incrementing a bookmark count associated with the resource, updating a list of tags associated with the resource and generating and storing a ranking score of the resource.

### COPYRIGHT NOTICE

A portion of the disclosure of this patent document includes material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention generally relates to ranking content items. More specifically, embodiments of the invention are directed towards systems, methods and computer program products for systematically ranking the popularity of resources in a social bookmarking environment.

### BACKGROUND OF THE INVENTION

The concept of Internet bookmarking has been closely tied with the concept of the Internet browser since the conception of the first popular browser, Mosaic. Bookmarks provide an easy way for a user to store and organize a collection of useful, interesting or favorite Internet pages found on the web. As the corpus of content available on the Internet grows, the bookmarking concept has become increasingly relevant, with locating data becoming an increasingly lucrative business.

Unfortunately, client-side bookmarks are generally confined to one computer and possibly to one specific browser. Although exceptions to this may occur, including transporting bookmarks on a disc, etc, bookmarks were confined to a single computer. Additionally, client-side bookmarks and bookmarking systems are generally static systems. A user selects a URL, which may include the title of a page, for storage on a file or in files on the user disk. Some sorting and searching functionality may be added to the browser, but the overall system is rather simplistic.

With the growth of the Internet and its inherent social characteristics, social bookmarking was created. Social bookmarking functions by moving the storage of bookmarks from the client-side to the server-side, in structures such as databases. A user may access his or her bookmarks through a web-based front end using a browser, or more recently through browser extensions, plug-ins or other helper applications. With the advent of the web-based bookmarking interface, users are no longer confined to the use of bookmarks on one device.

The social bookmarking concept has another added benefit: a wealth of data from a large sample-set of users. Since a server-side bookmark manager handles bookmarks for many users, analytics related to what is being saved by who may be leveraged. Thus, there is a need in the art for systems, methods and computer readable media for ranking social bookmarks to provide the most popular and freshest bookmarks to a user.

### SUMMARY OF THE INVENTION

The present invention is directed towards system and methods for ranking a plurality of social bookmarks. The system of the present invention comprises a plurality of client devices coupled to a network and a content provider coupled to the network.

The content provider may be operative to receive a bookmark request from a client device, the request comprising an identification of a resource and one or more tags. In a one embodiment, the identification of a resource may comprise a uniform resource locator and the one or more tags may comprise user-defined tags. Additionally, in an alternative embodiment, identification may comprise identifying a title of the resource. Receiving a bookmark request may be performed in real-time or as a batch process.

The content provider may further be operative to increment a bookmark count associated with the resource, update a list of tags associated with the resource and generate and store a ranking score of the resource in a database. In a one embodiment, the ranking score may be generated by dividing the number of tags by the bookmark count and comparing the resulting value to one. The ranking score may then be ranked with respect to one or more previously generated ranking scores. In an alternative embodiment, the system may further comprise a normalizing module operative to normalize the ranking score.

The present invention is further directed towards a method for ranking a plurality of social bookmarks. The method of the present invention comprises receiving a bookmark request, the request comprising an identification of a resource and one or more tags. In a one embodiment, the identification of a resource may comprise a uniform resource locator and the one or more tags may comprise user-defined tags. Additionally, in an alternative embodiment, identification may comprise a title of the resource. Receiving a bookmark request may be performed in real-time or as a batch process.

A bookmark count associated with the resource may be incremented and a list of tags associated with the resource updated. A ranking score of the resource may be generated and stored. In a one embodiment, the ranking score may be generated by dividing the number of tags by the bookmark count and comparing the resulting value to one. The ranking score may then be ranked with respect to a plurality of previously generated ranking scores. In an alternative embodiment, the system may further comprise normalizing the ranking score.

### BRIEF DESCRIPTION OF THE DRAWINGS

The invention is illustrated in the figures of the accompanying drawings which are meant to be exemplary and not limiting, in which like references are intended to refer to like or corresponding parts throughout, and in which:

FIG. 1 is a block diagram illustrating a system for ranking the popularity of content items in social bookmarking environment according to one embodiment of the present invention.

FIG. 2 is a flow diagram illustrating a method for receiving bookmark requests from a given user and updating bookmark statistics associated with a given bookmarked resource according to one embodiment of the present invention;

FIG. 3 is a flow diagram illustrating one embodiment of a detailed method for updating statistics of bookmark resources, including previously bookmarked resources, according to one embodiment of the present invention; and

FIG. 4 is a flow diagram illustrating a method for calculating a popularity score of a bookmarked resource according to one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

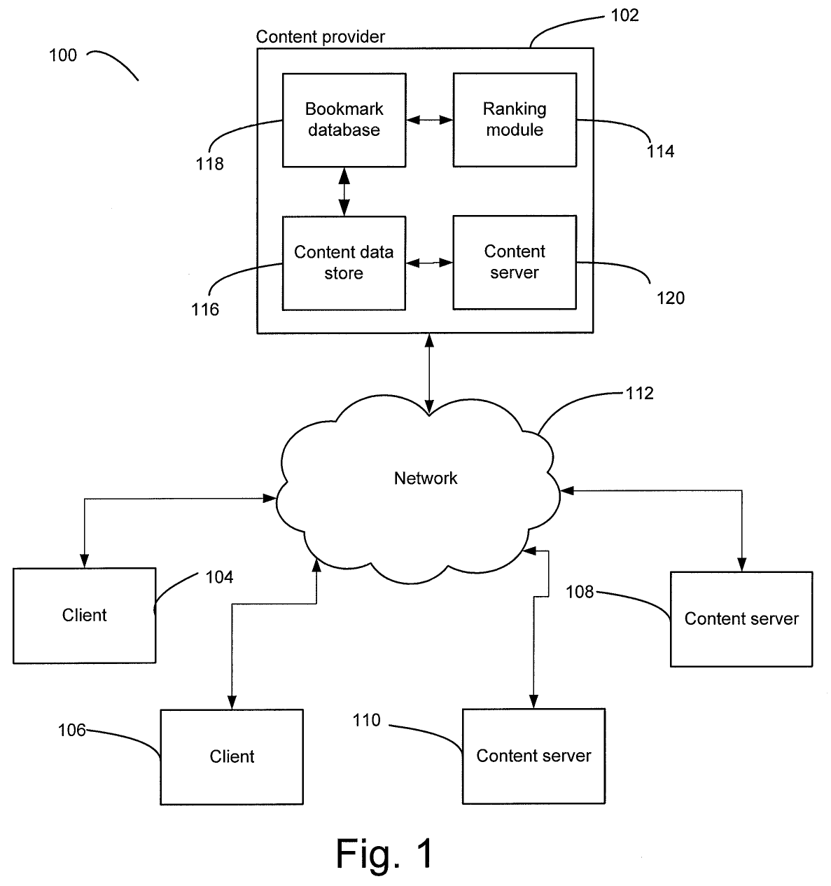

FIG. 1 presents a block diagram illustrating a system for ranking the popularity of content items in social bookmarking environment. According to the embodiment that FIG. 1 illustrates, one or more client devices 104 and 106 are communicatively coupled to a network 112, which may include a connection to one or more local and wide area networks, such as the Internet. According to one embodiment of the invention, a given client device 104 and 106 is general-purpose personal computer comprising a processor, transient and persistent storage devices, input/output subsystem and bus to provide a communications path between components comprising the general-purpose personal computer. For example, a 3.5 GHz Pentium 4 personal computer with 512 MB of RAM, 40 GB of hard drive storage space and an Ethernet interface to a network. Other client devices are considered to fall within the scope of the present invention including, but not limited to, hand held devices, set top terminals, mobile handsets, PDAs, etc.

A given client device 104 and 106 may be in communication over the network 112 with a content provider 102 that hosts one or more content items within a content data store 116. The content provider 102 may also comprise a bookmark database 118 for the storage and transmission of one or more bookmarks in response to a request from a client device 104 and 106. For example, the content provider 102 may comprise a web site that includes a content server 120 (e.g., Apache™, Internet Information Server™, etc.) and a data store, which according to one embodiment is a database that maintains web pages in an organized and structured manner. The content provider 102 may further maintain program code that, when executed by the content provider 102, is operative to dynamically generate one or more content items.

Content provider 102 may also comprise a ranking module 114. Ranking module 114 may be operative to rank a plurality of bookmarks present within bookmark database 118. Ranking module 114 may be implemented by a server-side software module such as a Perl, PHP, C or Java module. According to one embodiment, the ranking module 114 is operative to analyze bookmark database 118 and provide an indication of a popularity of a given bookmark present therein. In the illustrated embodiment, ranking module 114 may be operative to analyze data within bookmark database 118 and update the database with an indication of the popularity of a given bookmark in the database. In alternative embodiments, ranking module 114 may store the ranking data within the module itself. Ranking module 114 may further be operative to update bookmark database 118 in real time in response to bookmark requests received from a given client 104 and 106.

In one embodiment, a bookmark database 118 comprises or otherwise maintains a plurality of fields associated with a given bookmark. For example, a given bookmark may be associated with a bookmark count, a plurality of tags and a bookmark ranking score. In one embodiment, a bookmark count for a given bookmark is incremented by ranking module 114 in response to receiving a bookmark request from a given user. Tags may be assigned to a given bookmark in response to receiving a plurality of tags from a user. For example, a bookmark database 118 may contain the following entry:

| Bookmark | Bookmark Count | Tags | Ranking Score |
|---|---|---|---|
| Yahoo.com | 7 | search engine, | 0.71 |
| | | search, yahoo, | |
| | | portal, directory | |

### EXAMPLE 1

A given user may decide to bookmark a resource corresponding to the entry in Example 1 (e.g., a web page located at http://www.yahoo.com/). In a bookmark request, a user may tag the resource with the tags “homepage, yahoo, search, mail”. In response to a bookmark request, ranking module updates the corresponding entry as follows:

| Bookmark | Bookmark Count | Tags | Ranking Score |
|---|---|---|---|
| Yahoo.com | 8 | search engine, | 0.88 |
| | | search, yahoo, | |
| | | portal, directory, | |
| | | homepage, mail | |

### EXAMPLE 2

As Example 2 illustrates, ranking module 114 updates a bookmark count within bookmark database 118 to reflect an additional bookmark request (7 is incremented to 8). Additionally, the incoming tags are analyzed against the existing tags for a bookmark and newly entered tags are placed within the entry (e.g., “homepage” and “mail” are determined to be newly entered tags while “homepage” and “yahoo” are already present within the database.

Additionally, a ranking module 114 updates the ranking score associated with a given bookmark entry present in bookmark database 118. In Examples 1 and 2, a simplistic algorithm of dividing the number of tags by the bookmark count is utilized to form the ranking score. In alternative embodiments, various other algorithms and functions may be utilized, as will be described in greater detail herein.

Content server 120 may be operative to retrieve a plurality of content pages from content data store 116. Content data store 116 may store static content items, as well as pages generated on the basis of data stored within bookmark database 118. In an alternative embodiment, content data store 116 may generate dynamic pages on the basis of both bookmark data from bookmark database 118.

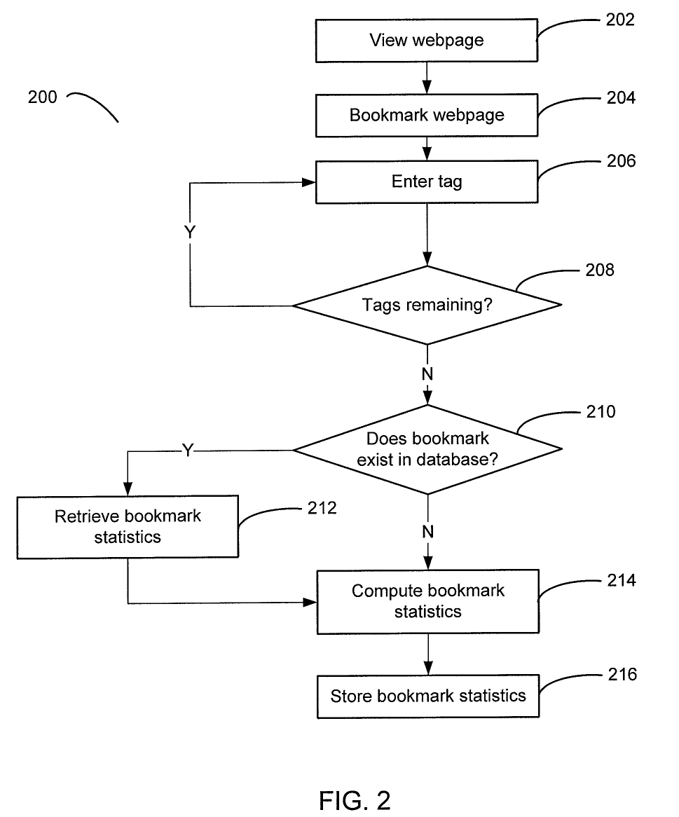

FIG. 2 presents a flow diagram illustrating a method for receiving bookmark requests from a given user and updating bookmark statistics associated with a given bookmarked resource according to one embodiment of the present invention. As previously described, a user may navigate to a given resource (such as a webpage), step 202, and select an option to bookmark the viewed resource, step 204. In alternative embodiment, a user may bookmark a non-viewed resource. For example, a user may manually enter a URL of a resource he or she wishes to bookmark. An option to bookmark a viewed resource may comprise a toolbar button, a component located within the resource, a keystroke, a browser option activated via user input (such as a right mouse click), etc.

After selecting an option to bookmark a given resource, a user may enter one or more tags to describe the viewed resource, step 206. A tag may comprise one or more terms such as “movies”, “tickets”, “showtimes” etc. In one embodiment, a user is presented with a plurality of suggested tags based on previously entered tags, resource content or a combination of both. A user may continue to enter tags until he or she determines that an appropriate amount have been entered to describe the viewed resource, step 208. Alternatively, an upper bound may be placed on the total number of entered tags. For example, a limit on the number of entered tags may be enabled to account for limitations in the amount of data transferred from a given client device to a receiving server, thus avoiding arbitrary truncating of returned data.

Upon receiving a bookmark request, steps 204, 206 and 208, a bookmark database may be queried to determine if the requested bookmark is present within a database of existing bookmarks, step 210. In one embodiment, a bookmark is checked as it is bookmarked by a user via steps 204, 206 and 308. For example, a user may request to bookmark a given resource X with a plurality of tags {Y}. Upon receipt, a server may query a database of previously bookmarked items {B} to determine if X is present within the database {B}. In an alternative embodiment, bookmarks may be checked by performing a batch process where a plurality of new bookmarks are checked via a reoccurring batch process.

If the requested bookmark is already present within the bookmark database, step 210, bookmark statistics are retrieved, step 212. In a one embodiment, bookmark statistics may include a bookmark count, list or bookmark tags or a bookmark ranking score. Bookmark statistics may be stored with a bookmark identifier in a structure such as a database, or alternatively may be stored separate from the bookmark identifier.

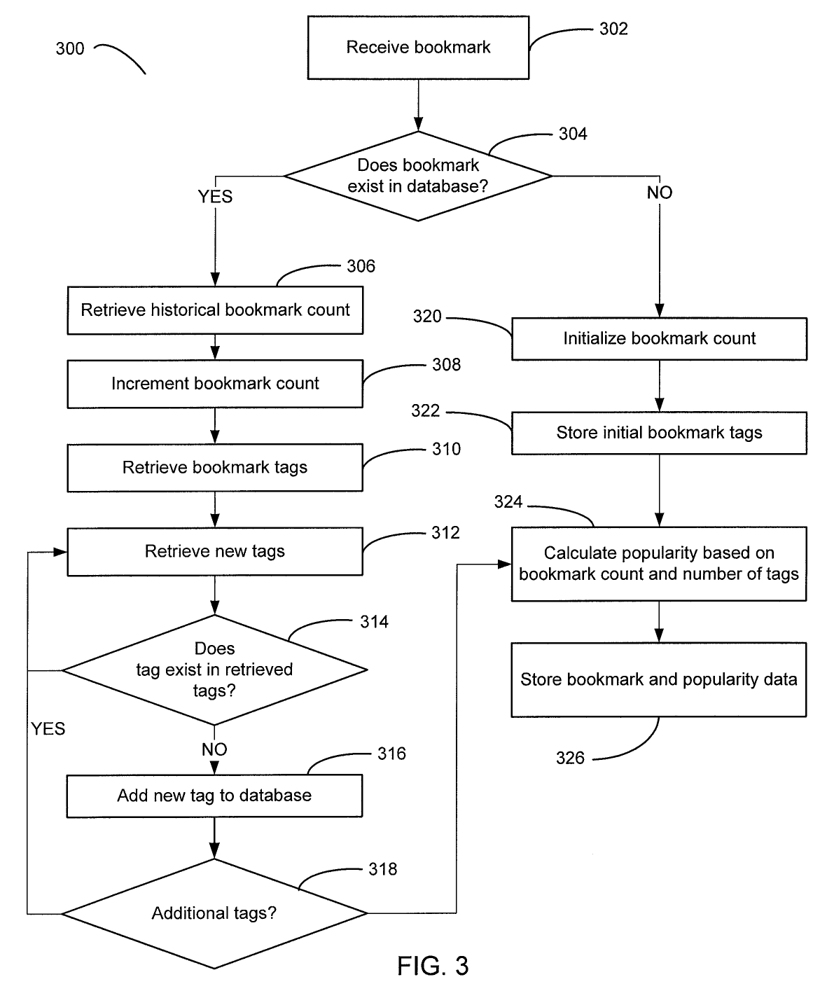

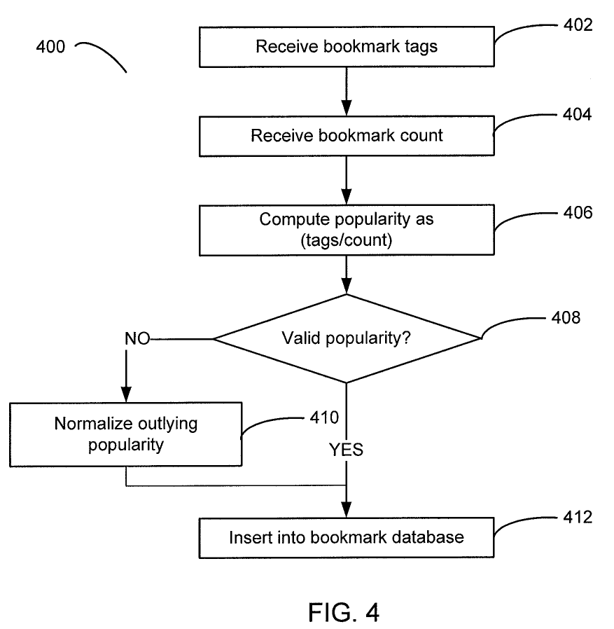

Bookmark statistics may be generated for a bookmarked resource, step 214, and an updated bookmark stored, step 216. If bookmark statistics are already present for a given bookmark, the new bookmark statistics entered by a user, steps 204, 206 and 308, may be combined to form a final set of bookmark statistics. If no bookmark exists, the statistics retrieved from a user in steps 204, 206 and 308 are utilized to generate initial statistics for a given bookmark. The process of generating bookmark statistics is described more fully with respect to FIGS. 3 and 4.

FIG. 3 presents a flow diagram illustrating one embodiment of a detailed method for updating statistics of bookmark resources including previously bookmarked resources according to one embodiment of the present invention. As illustrated, a bookmark is received, step 302. Selecting to bookmark a viewed resource may be accomplished via a browser extension such as a toolbar button, dropdown menu option or shortcut key. Alternatively, a hyperlink may be embedded within the currently viewed resource that may allow a user to bookmark the viewed resource. When a user bookmarks a viewed resource (such as a webpage), he or she is given an option to modify metadata associated with the viewed resource. In a one embodiment, this metadata may correspond to tags that briefly describe the subject matter of the viewed resource. For example, a user may navigate to “http://www.yahoo.com” and opt to bookmark the URL. A dialog may appear asking the user to provide additional, optional information, such as tags. Appropriate tags may include “search engine”, “yahoo”, “search”, etc. It should be noted that the described tags are of free-form nature, that is, a user may enter tags of his or her choosing, regardless of their association with the viewed resource.

A check is performed to determine if a resource has been bookmarked, step 304. If a resource has not been bookmarked before, a bookmark count is initialized, step 320. In a one embodiment, the first time a bookmark is received, a bookmark count may accordingly be initialized to a value of one. Subsequently, a plurality of bookmark tags may be stored, step 322. In the presently illustrated embodiment, if a resource is identified as a newly bookmarked resource (step 304), the method 300 may be operative to store all tags entered by a user. As previously described, appropriate tags for the present example may include, but are not limited to, “search engine”, “yahoo”, “search”, etc. In one embodiment, a count of the number of tags is initialized upon receipt of the plurality of tags. In alternative embodiments, a count of the number of tags may be generated at runtime based on analysis of the number of tags associated with a given resource.

If a resource has previously been bookmarked, a bookmark count is retrieved, step 306. As previously discussed, a bookmark count may be stored in a data structure in addition to the stored bookmark. The bookmark count value may be incremented to account for the new bookmark request for a current resource, step 308. For example, a user may request to bookmark a given resource associated with the URL “http://www.yahoo.com”. Assuming this resource has previously been bookmarked, a bookmark count associated with the resource is retrieved (e.g., 23460 times bookmarked) and incremented to reflect the incoming bookmark request (e.g., 23461 times bookmarked).

The bookmark tags are then retrieved for a previously bookmarked resource, step 310. As previously described, a tag may comprise a user entered term describing the bookmarked resource. A plurality of previously entered tags may be retrieved from a structure such as a central database and each tag may be examined against each entered tag, step 312. That is, each new tag may be verified against the existing list of tags to determine which of the newly entered tags are unique for a previously entered bookmark.

If the newly entered tag already exists within a list of bookmark tags, the newly entered tag is discarded and a subsequent tag is retrieved, step 314. If not, the newly entered tag is associated with the resource being bookmarked, step 316. In a one embodiment, storing a tag may comprise added the tag to a database. In one embodiment, a database may comprise a plurality of bookmarks and a plurality of corresponding tags. In alternative embodiments, tags maybe stored in a database separate from the bookmark database. A final check is performed to determine if any more newly entered tags remain to be reviewed, step 318. If so, steps 312, 314, 316 and 318 are repeated for the remaining tags.

The tags have been inspected and a popularity score for a given bookmark is computed, step 320. A popularity score may be determined based on a plurality of factors including the number of times a resource was bookmarked and the number of tags used to classify a given resource. The process of determining a popularity score is described more fully with respect to FIG. 4. A popularity score generated in step 320 may be stored along with bookmark and tag data. In alternative embodiments, a popularity value may be stored in a separate data structure. After the popularity has been determined, the updated bookmark data and popularity data are stored, step 326.

FIG. 4 presents a flow diagram illustrating a method for calculating a popularity score of a bookmarked resource according to one embodiment of the present invention. The method of FIG. 4 may be performed in real-time upon a bookmark request or alternatively may be performed as a batch process on a set of one or more bookmarks.

As illustrated, the method 400 retrieves one or more tags, step 402, as well as a bookmark count, step 404. As previously described, bookmark tags may comprise one or more terms entered by users that describe a given resource represented by a bookmark and a bookmark count may represent the number of times a given resource has been bookmarked.

The retrieved tags and bookmark count are utilized to formulate a popularity value, step 406. In a one embodiment, a popularity value may comprise the result of a division of the number of tags by the number of times a given resource has been bookmarked. The close the popularity value is to one indicates the popularity of a given bookmark. For example, a bookmark with a popularity of 0.9 will be considered more popular than a second bookmark with a popularity of 0.5.

After the popularity of a bookmark is determined, the method 400 checks to determine if the popularity value is a valid result, step 408. A check is needed to ensure the integrity of the popularity rankings. For example, a resource bookmarked only once with ten tags may yield a popularity value of 10. Invalid results are thus normalized, step 410, before being inserted into a database, step 412.

A normalization function may comprise any function operable to prune invalid bookmarks from a bookmark database. For example, a simple normalization function may consist of simply discarding popularity values above the value of one. However, more complex normalization functions may be utilized such as the multiplication of the popularity value by an exponentially decreasing function and/or a unit pulse function.

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for ranking a plurality of social bookmarks, the method comprising:
receiving a bookmark request, the request comprising an identification of a resource and one or more tags;
incrementing a bookmark count associated with the resource;
updating a list of tags associated with the resource; and
generating and storing a ranking score of the resource on the basis of the list of tags and the bookmark count.

2. The method of claim 1, wherein the identification of a resource comprises a uniform resource locator (URL).

3. The method of claim 2, wherein the identification of the resource comprises identifying a title of the resource.

4. The method of claim 1, wherein a plurality of resource tags comprises user-defined tags.

5. The method of claim 1, wherein receiving a bookmark request is performed in real time.

6. The method of claim 1, wherein receiving a bookmark request is performed as a batch process.

7. The method of claim 1, comprising normalizing the ranking score of the resource.

8. The method of claim 1, wherein the ranking score is generated by dividing the number of tags by the bookmark count and comparing the resulting value to one.

9. The method of claim 8, wherein the ranking score is ranked with respect to a plurality of previously generated ranking scores.

10. A system for ranking a plurality of social bookmarks comprising:
one or more client devices coupled to a network;
a content provider coupled to the network, in communication with the plurality of clients, the content provider operable to receive a bookmark request, the request comprising an identification of a resource and one or more tags;
increment a bookmark count associated with the resource;
update a list of tags associated with the resource; and
generate and store a ranking score of the resource in a database on the basis of the list of tags and the bookmark count.

11. The system of claim 10, wherein the identification of a resource comprises a uniform resource locator (URL).

12. The system of claim 11, wherein the identification of a resource comprises a title of the resource.

13. The system of claim 10, wherein the one or more tags comprises user-defined tags.

14. The system of claim 10, wherein receiving the bookmark request is performed in real time.

15. The system of claim 10, wherein receiving the bookmark request is performed as a batch process.

16. The system of claim 10, further comprising a normalizing module operative to normalize the ranking score of the resource.

17. The system of claim 10, wherein the ranking score is generated by dividing the number of tags by the bookmark count and comparing the resulting value to one.

18. The system of claim 17, wherein the ranking score is ranked with respect to a plurality of previously generated ranking scores.
